(19) United States
(12) Patent Application Publication
(10) Pub. No.: US 2010/0022010 A1
(43) Pub. Date: Jan. 28, 2010

(54) CHEMICAL AGENT DETECTION METHOD AND APPARATUS

(75) Inventors: Amy E. Stevens, Lexington, MA (US); Anne Ehret, Estes Park, CO (US); Louis S. Stuhl, Bedford, MA (US)

Correspondence Address: SEYFARTH SHAW LLP, WORLD TRADE CENTER EAST, TWO SEAPORT LANE, SUITE 300, BOSTON, MA, 02210-2028, US

(73) Assignee: CHEMMOTIF INC., Concord, MA (US)

(21) Appl. No.: 11/915,182

(22) PCT Filed: May 24, 2006
(86) PCT No.: PCT/US2006/020030

§ 371 Date: Dec. 12, 2007

Related U.S. Application Data
(60) Provisional application No. 60/683,900, filed on May 24, 2005.

(51) Int. Cl. G01N 37/00

(52) U.S. Cl. 436/56

(57) ABSTRACT

A method and apparatus for detecting Chemical Warfare Agents (CWA) and Toxic Industrial Chemicals (TICs) that is simple, cost-effective, non-instrumental, and environmentally robust. Illustrative embodiments provide a material that responds by a color change and/or a change, in fluorescence when exposed to the toxic-chemical vapors.

### CROSS REFERENCE TO RELATED APPLICATIONS

This application claims priority to U.S. Provisional Patent Application Ser. No. 60/683,900 which is incorporated herein by reference in its entirety.

### FIELD OF THE INVENTION

The present invention relates to the field of toxic chemical detection.

### BACKGROUND OF THE INVENTION

Various methods are known for detection of toxic chemicals. Most of these methods involve the use of complex and expensive instrumentation. The acute toxicity of Chemical Warfare Agents and Toxic Industrial Chemicals creates a need for a detection method and apparatus that is simple, cost effective, non-instrumental and environmentally robust.

### SUMMARY OF THE INVENTION

Embodiments of the present invention provide a method and apparatus for detecting Chemical Warfare Agents (CWAs) and Toxic Industrial Chemicals (TICs) that is simple, cost-effective, non-instrumental, and environmentally robust. Illustrative embodiments provide a material that responds by a color change and/or a change in fluorescence when exposed to the analyte vapor.

An illustrative embodiment of the invention provides a visual toxic chemical detector including a soluble non-enzymatic degradation agent combined with an acid-base indicator.

The illustrative embodiments can also include co-reagents, polymers, plasticizers and/or surfactants combined with said degradation agent and the indicator. In the illustrative embodiment a fluorescent dye or a pigment can be coupled to the acid-base indicator.

Another illustrative embodiment of the invention provides a toxic chemical detector including a vapor or aerosol detecting film comprising a soluble, non-enzymatic degradation agent and an acid-base indicator combined with the degradation agent. In the illustrative embodiment, the gas detecting film can also include a mixture including a polymer, a plasticizer, a surfactant, and a substrate at least partially coated with the mixture. The film can be disposed between a carbon bed of a gas mask canister and a transparent window of the gas mask canister.

Another illustrative embodiment of the present invention provides a method for detecting toxic chemicals. The illustrative method can be performed by providing an acid gas detector (AGD) including a film coated with a mixture including an acid-base indicator, a soluble non-enzymatic chemical degradation agent, and a fluorescent dye coupled to said indicator. The acid gas detector can be illuminated with a light having a frequency predetermined to excite the fluorescent dye. The acid-base indicator can be chosen to quench the fluorescence until the pH is shifted as a result of toxic chemical exposure. In its unquenched condition, the fluorescent dye can be a visible indicator of the presence of a toxic chemical.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 is a diagrammatic representation of the chemical mechanism involved in agent-induced fluorescence according to illustrative embodiments of the present invention;

FIG. 2 is a graph illustrating the fluorescence emission of a typical fluorescent dye and how its fluorescence can be quenched by an acid-base indicator dye in the unexposed detector and then revealed by exposure of the detector to an analyte that triggers a pH change in the detector according to an illustrative embodiment of the present invention;

FIG. 3 is an illustration showing the use of the AGD material in the form of an adhesive spray according to an illustrative embodiment of the invention;

FIG. 4 is an illustration of a CWA detection badge used according to an illustrative embodiment of the invention;

FIG. 5 is an exploded diagrammatic representation of a CWA detector for use in a gas mask filter according to an illustrative embodiment of the invention; and

FIG. 6 is an illustration of a CWA detector window disposed on a gas mask canister according to an illustrative embodiment of the present invention.

### DETAILED DESCRIPTION

An illustrative embodiment of the invention provides a material that reacts with a broad range of analytes. The analyte (hereafter referred to as “acid-forming gases,” or AG; in this context the word “gases” is taken to include any species dispersed in an atmosphere, including aerosols and fine particulates) belongs to a class of chemicals that will degrade to produce an acid decomposition product. In illustrative embodiments, the degradation reaction is in the class of reactions known as “hydrolysis” in which the AG is cleaved and a water molecule (H₂O) added at the site of the cleavage whereby —H is added to one of the cleavage products and —OH is added to the other of the cleavage products. The resulting production of acid increases the acidity of the medium. In the detector the increased acidity lowers the pH of the solution. The acidity change can be monitored visually by including an acid-base indicator dye in the material.

When acid is produced, an acid-base indicator dye can be chosen that will respond to the increase in acidity by going from its basic, deprotonated form (in unexposed material) to its acidic, protonated form (in material exposed to an AG). Acid-base indicator dyes change color on protonation, thereby providing a visual signal that the acidity has increased, i.e., the material has been exposed to an acid gas. The material described in the illustrative embodiments of the invention can thereby be used as an “acid-gas detector,” or AGD. The material's response to AG exposure is generally non-reversible, and therefore it can create a permanent record of the exposure.

The AGD produced according to illustrative embodiments of the invention can be a multi-component material for application to a surface or substrate as an aqueous mixture or paint and allowed to dry to form a thin film. The time until response can depend in part on the thickness of the film. Accordingly, the sensitivity of a detector can be adjusted by appropriate choice of the film thickness. A number of exemplary formulations of the AGD material have been prepared and tested according to illustrative embodiment of the present invention. The illustrative formulations contain mixtures of a polymer which provides a film matrix for the reagents and plasticizer which provides flexibility to the dry film and acts as a solvent for the reaction chemistry in the film. The illustrative mixtures also contain a surfactant which accelerates uptake of the analytes into the film, accelerates response time of the film and enhances wettability of the mixture for painting a uniform coating on a surface. The illustrative mixtures also contain an acid-base indicator dye which responds to increasing acidity by a color change and a soluble non-enzymatic chemical degradation agent which degrades the analyte to acidic components, for example, by catalytic or reactive chemistry. The term “soluble,” as used here to describe the degradation agent means that the degradation agent remains dissolved or colloidally dispersed in the plasticizer/surfactant/polymer in the “dried” film detection material.

Illustrative embodiments of the invention also contain a latex which imparts water resistance, increases adhesion to the substrate surface and increases resiliency of the film. In another embodiment, the invention contains an opacifying agent such as titania or other chemical agents as appropriate to make the resulting film translucent, for example, so that the material can be viewed against a dark background.

In illustrative embodiments, a fluorescent dye can be added to the detector material so that exposure of the material to an AG can cause the material to become fluorescent. In this embodiment, the acid-base indicator can be chosen to be dark-colored in its basic form, with its absorption of light in the same spectral region as the fluorescence (emission) spectrum of the fluorescent dye. In this way the acid-base indicator dye when in its basic form will re-absorb and/or quench the fluorescence of the fluorescent dye. The acid-base indicator can be further chosen so as to be “light-colored” (or colorless) in the acidic form, with its absorption of light at higher energies (bluer) than the fluorescence emission of the fluorescent dye. In this way when the indicator dye is in the acidic form, the emission from the fluorescence dye is not absorbed or quenched, but the fluorescent dye can be excited and the emission fluorescence observed.

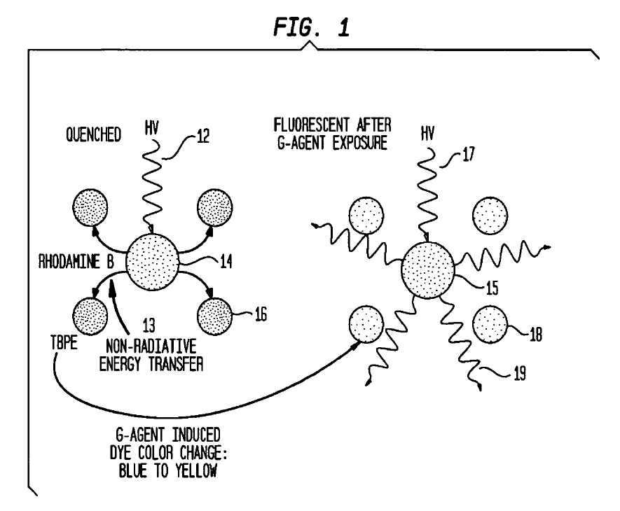

FIG. 1 is a diagrammatic representation of the chemical mechanism involved in fluorescent readout of a detector according to illustrative embodiments of the present invention. In the detector prior to exposure to an analyte, exposure of the detector to an excitation light source does not yield fluorescence because the energy of the incoming photons 12 is transferred 13 from the fluorescent dye 14 to the appropriately chosen non-fluorescent acid-base indicator dye 16 faster than fluorescence emission can occur. When the detector is exposed to an analyte that will produce acid via interaction with the chemical degradation agent, such as a G-Agent nerve gas, the color of the indicator 18 is shifted to a higher energy, thereby preventing energy transfer from the fluorescent dye 15 and resulting in the appearance of fluorescence because the energy of incoming photons 17 is not transferred from the fluorescent dye 15 to the indicator dye 18 faster than fluorescence emissions 19 can occur.

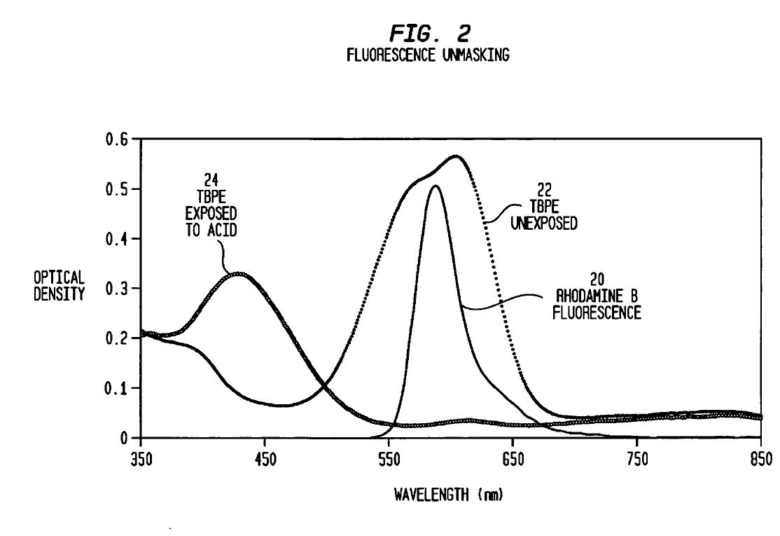

FIG. 2 is a graph illustrating how fluorescent readout of the AG detector can occur via the spectral overlap of an acid-base indicator, TBPE, and a fluorescent dye. In this example, a spectral overlap exists between the fluorescent dye, Rhodamine B 20, in the detector and TBPE 22 before exposure to an acid-forming analyte. A spectral overlap does not exist between the fluorescent dye, Rhodamine B 20 in the detector and TBPE 24 after exposure to an acid-forming analyte. The loss of spectral overlap permits the appearance of fluorescence after exposure to the acid-forming analyte. The indicator dye can be chosen such that its visible light absorption spectrum peaks at a lower energy in the unexposed form and at higher energy when the pH is lowered by acid formation in the detector. The fluorescent dye or pigment can be chosen such that its fluorescence emission maximum occurs at a comparable energy to the absorption maximum of the unexposed (higher pH) form of the indicator dye, resulting in inhibition of fluorescence in the unexposed detector.

In illustrative embodiments, a soluble, non-enzymatic degradation agent can be combined with an acid-base indicator. Examples of such soluble, non-enzymatic degradation agents that can be used in the AGD include: copper salts such as copper(II) sulfate or copper(II) nitrate; copper(tetramethylethylenediammine)(II) nitrate; copper(II)(trimethyl-hexadecylethylenediamine); iodosobenzoic acid and its derivatives; oximes such as 1,3-diphenyl-1,2,3-propanetrione-2-oxime or pyridinealdoxime methiodide. Other chemicals known to degrade CWAs or TICs that can be used as degradation agents in illustrative embodiments of the invention include, for example, salts containing the hypochlorite ion, or salts or complexes containing zinc or other metals known to catalyze hydrolysis. Depending on the degradation agent, a co-reagent (e.g., sodium bicarbonate) may be used in the material. Examples of suitable acid-base indicator dyes that are suitable for use in illustrative embodiments of the invention include Phenolphthalein, Bromophenol Blue, Bromocresol Green, Bromocresol Purple, Bromothymol Blue, the potassium salt of Tetrabromophenolphthalein ethyl ester, Nitrazine Yellow, Phenol Red, Chlorophenol Red, Brilliant Green, Alizarin Red S, and the like. Choice of the acid-base indicator depends on the degradation reagent and other film components.

In illustrative embodiments, the response time of a detector can be predetermined (within limits) by changing the acid-base indicator dye in the film. For example, the response time can be increased by changing the acid-base indicator dye from one that protonates at a higher pH (less acidic) such as Bromophenol Blue to one that protonates at a lower pH (more acidic) such as Brilliant Green.

In illustrative embodiments, surfactants can be used in the detector film. The use of surfactant and the chemical character of the surfactant(s) can be critical to provide rapid uptake of the analyte gas into the film. Surfactants can aid diffusion of the analyte through the film, and enhance the reaction rate, for example, by bringing a hydrophobic analyte in closer proximity to a hydrophilic degradation agent.

In illustrative embodiments of the invention, a plasticizer can be used in the polymeric film matrix. The particular plasticizer makes a difference in the response time. The plasticizer can act as a solvent for diffusion of the analyte into the film. In the illustrative embodiments, the plasticizer can also act as a solvent for the degradation agent, any co-reagents, associated reaction chemistry and/or for the indicator and fluorescent dyes.

Illustrative embodiments of the present invention can detect a number of CWAs and TICs such as for example, mustard gas, Sarin, phosgene, diethyl chlorophosphate, sulfur dioxide, cyanogen chloride, and chlorine. Accordingly such embodiments can be used as broad-screen detectors. In some embodiments, combination of the acid-base indicator dye to a fluorescent dye can provide a fluorescence response on exposure. These embodiments can be used as a fluorescent AGD sensor without the need for the reactive chemistry to itself create a fluorescent product molecule.

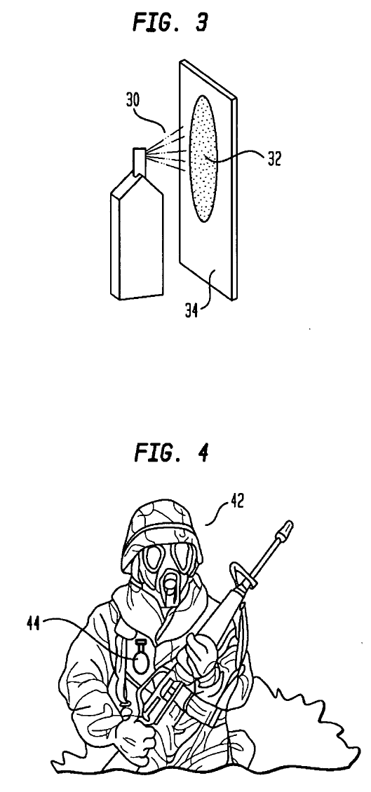

Illustrative embodiments of the present invention provide a material in the form of a paint that can be applied by the user to surfaces such as, for example, by using a fine-art grade airbrush, such as a Paasche VL-SET Airbrush, for example. The AGD material can be supplied as a sprayable, or otherwise coatable, paint that adheres to surfaces including concrete, stainless steel, wood, glass, and the like. FIG. 3 illustrates the use of the AGD material in the form of an adhesive spray 30 to provide an AGD sensing layer 32 on a substrate 34. In alternative embodiments, the AGD may be supplied as a dried film on a substrate, such as, for example, on transparent, subbed polyester. Illustrative embodiments of the invention provide a AGD film that is not water soluble and is suitable for outdoor use.

Embodiments of the present invention can be implemented as a badge worn by military personnel in the field to warn of CWA exposure. FIG. 4 is an illustration of a soldier 42 wearing such a CWA detection badge 44 according to an illustrative embodiment in which the CWA detection badge can be made in camouflaged color patterns to blend visually with the soldier's uniform and environment. An alternative embodiment can be incorporated into a gas-mask canister or room filter to serve as an end-of-service life indicator (ESLI).

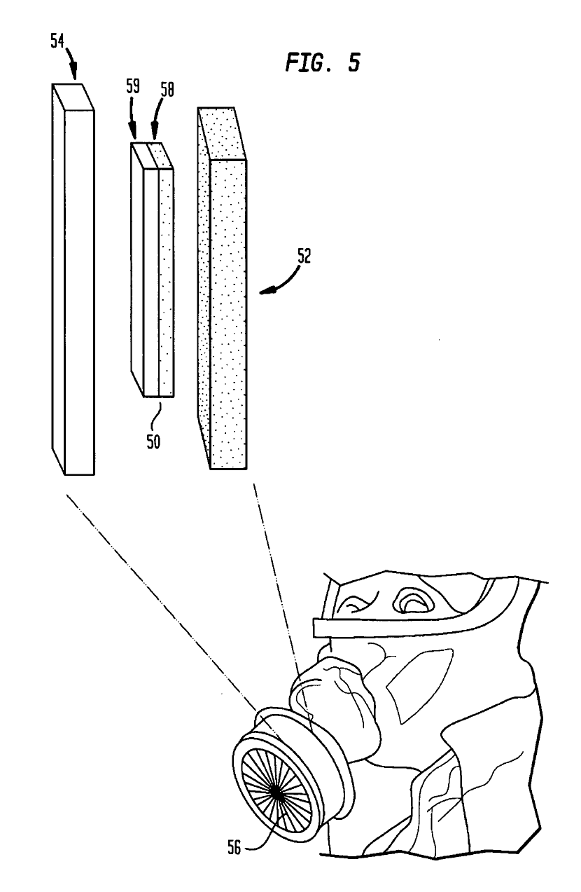

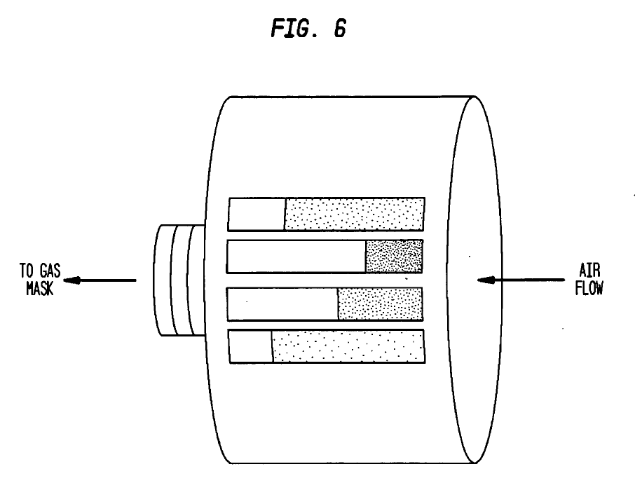

In an illustrative embodiment, described with reference to FIG. 5, the detector material can be provided on a film 50 that can be disposed between a carbon bed 52 of a gas mask canister 56 and a transparent window 54 of the gas mask canister 56. In this embodiment film 50 includes a translucent sensor layer 58 containing white pigment for visibility. The sensor layer 58 is disposed on a transparent polyester film base 59. FIG. 6 illustrates placement of a CWA detector 60 in a window disposed with a gas mask canister 62.

Embodiments of the present invention which include a fluorescent material can be used for perimeter or compliance monitoring of a military installation, or for monitoring of a site used for storage and/or destruction of chemical weapons wherein the response could more easily be monitored remotely. In these embodiments the film can be monitored remotely by irradiating with light of a given frequency and detection of the fluorescence, for example. Alternative embodiments may be monitored using instrumentation to record the light absorption (and hence color) or fluorescence of the detector as it changes with time.

### EXAMPLE

A coating fluid can be prepared by combining the following solutions and solids in the amounts stated with sufficient mixing.

| | |
|---|---|
| 5% Methocel ™ K35LV^{a} | 2.544 g |
| hydroxypropylmethylcellulose in water | |
| 1.56% 1,3,-diphenyl-1,2,3-propanetrione-2- | 0.234 g |
| oxime in ethanol | |
| glycerol^{c} | 0.107 g |
| 10% Pluronic ™ P103^{b} in water | 0.100 g |
| Phenol Red^{c} | 0.007 g |
| 4.2% sodium bicarbonate in water | 0.0013 g |

^{a}Dow Chemical
^{b}BASF Corp.
^{c}Sigma-Aldrich

This fluid is coated onto a polyester film (subcoated for aqueous adhesion) using a #28 wound-wire coating rod (RD Specialties, Webster, N.Y.) and is then dried in a 110° C. convection oven for 5 minutes. The result is a magenta-colored film that turns yellow on exposure to acids or analytes such as phosgene or sarin.

Although the invention has been shown and described with respect to exemplary embodiments thereof, various other changes, omissions and additions in the form and detail thereof may be made therein without departing from the spirit and scope of the invention.

What is claimed is:

1. A visual toxic chemical detector comprising:
a soluble, non-enzymatic degradation agent; and
an acid-base indicator combined with said degradation agent.

2. The detector according to claim 1, wherein said degradation agent is selected from the group consisting of: copper(II) sulfate; copper(II) nitrate; copper(II) (tetramethylethylenediammine) nitrate; copper(II)(trimethyl-hexadecylethylenediamine) nitrate; iodosobenzoic acid and derivatives thereof; oximes, including 1,3-diphenyl-1,2,3-propanetrione-2-oxime and pyridine-2-aldoxime methiodide.

3. The detector according to claim 1, wherein said degradation agent is selected from the group consisting of salts containing the hypochlorite ion and salts containing zinc, iron, tin, nickel, scandium, yttrium, and lanthanide elements.

4. The detector according to claim 1 further comprising:
one or more co-reagents combined with said degradation agent and said indicator.

5. The detector according to claim 4 wherein said co-reagent is selected from the group consisting of sodium bicarbonate, potassium bicarbonate, lithium bicarbonate, and corresponding carbonate salts.

6. The detector according to claim 1, wherein said indicator is selected from the group consisting of: Phenolphthalein, Bromophenol Blue, Bromocresol Green, Bromocresol Purple, Bromothymol Blue, Tetrabromophenolphthalein, the potassium salt of Tetrabromophenolphthalein ethyl ester, Nitrazine Yellow, Phenol Red, Chlorophenol Red, Brilliant Green and Alizarin Red S.

7. The detector according to claim 1 further comprising:
a polymer combined with said degradation agent and said indicator.

8. The detector according to claim 7 comprising:
one or more surfactants combined with said polymer, said degradation agent and said indicator.

9. The detector according to claim 7 further comprising a plasticizer combined with said polymer, said degradation agent and said indicator.

10. The detector according to claim 7 further comprising a latex combined with said polymer, said degradation agent and said indicator.

11. The detector according to claim 7 further comprising an opacifying agent combined with said degradation agent and said indicator.

12. The detector according to claim 11, wherein said opacifying agent is selected from the group consisting of titanium dioxide and zinc oxide.

13. The detector according to claim 1 further comprising a fluorescent dye combined with said indicator.

14. The detector according to claim 1 further comprising an adhesive combined with said degradation agent and said an acid-base indicator

15. The detector according to claim 14, wherein said adhesive combined with said degradation agent and said acid-base indicator comprise a coating deployable as a paint.

16. The detector according to claim 14, wherein said adhesive is selected for adherence to a surface selected from the group consisting of concrete, stainless steel, wood, plastics, and glass.

17. The detector according to claim 1 further comprising a substrate at least partially coated with said degradation agent and said acid-base indicator.

18. The detector according to claim 17 further comprising attachment means for mounting said substrate on an article of clothing such that said coated portion of said substrate is visible and exposed to local gasses.

19. The detector according to claim 17:
wherein said substrate comprises a transparent film base; and
wherein said mixture is coated to a surface of said substrate.

20. The detector according to claim 19, wherein said mixture further comprises a pigment or unreactive dye.

21. A toxic chemical detector comprising:
an acid gas detecting film comprising a soluble, non-enzymatic degradation agent; and
an acid-base indicator combined with said degradation agent, said film being disposed between a carbon bed of a gas mask canister and a transparent window of said gas mask canister.

22. The toxic chemical detector according to claim 21, wherein said acid gas detecting film further comprises:
a mixture including a polymer, a plasticizer, a surfactant; and a substrate at least partially coated with said mixture.

23. A method for detecting toxic chemical comprising:
providing an acid gas detector including a film coated with a mixture including an acid-base indicator, a soluble non-enzymatic chemical degradation agent, and a fluorescent dye combined with said indicator;
illuminating said acid gas detector with light having a frequency predetermined to excite said fluorescent dye; and
wherein fluorescence resulting from excitation of said fluorescent dye is a visible indicator of the presence of a toxic chemical.

24. The detector according to claim 13, wherein said fluorescent dye is selected from the group consisting of: Rhodamine 123, Rhodamine B, Rhodamine 6G, Pyronin Y, oxonine, Basic Blue 3, Sulforhodamine B, Sulforhodamine C, Cresyl Violet, Nile Blue and Safranine O.
